(19) United States
(12) Patent Application Publication
(10) Pub. No.: US 2011/0006078 A1
(43) Pub. Date: Jan. 13, 2011

(54) BEVERAGE DEVICE AND TANK THEREOF

(76) Inventor: Kuang-Fu Hsu, Kaohsiung County (TW)

Correspondence Address: Muncy, Geissler, Olds & Lowe, PLLC, 4000 Legato Road, Suite 310, FAIRFAX, VA, 22033, US

(21) Appl. No.: 12/565,548

(22) Filed: Sep. 23, 2009

(30) Foreign Application Priority Data
Jul. 13, 2009 (TW) 098123647

(51) Int. Cl. B67D 5/64; B67D 5/63; B67D 5/62; F25B 1/00; B65D 81/38; B65D 25/40; F28F 7/00

(52) U.S. Cl. 222/129; 222/146.2; 222/146.6; 62/498; 220/592.2; 165/185

(57) ABSTRACT

A beverage device includes a body having a temperature control unit outputting a temperature by a conduit unit. At least one temperature conducting device is received in the body and connected to the conduit unit, keeping the at least one temperature conducting device at a first predetermined temperature. At least one tank receives a beverage and is in connection with the conduit unit of the at least one temperature conducting device to keep the beverage at a second predetermined temperature.

### BACKGROUND OF THE INVENTION

1. Field of the Invention

The present invention relates to a beverage device and, more particularly, to a beverage device including a tank that can be easily removed for cleaning.

2. Description of the Related Art

U.S. Pat. No. 5,427,276 discloses a machine for dispensing chilled alcoholic beverage including a housing receiving a cooling tank and a refrigeration cooling unit. The cooling tank is connected to a manifold in communication with at least one bottle so that a beverage in the bottle can flow into the cooling tank. The refrigeration cooling unit includes an evaporator coil extending through the cooling tank. Refrigerant flows through the evaporator coil to chill the beverage in the cooling tank. A beverage faucet is mounted to the cooling tank to allow dispensation of the chilled beverage. However, cleaning of the cooling tank includes troublesome and time-consuming detachment of the housing and elements connected to the cooling tank. Generation of bacteria is likely to occur if the cooling tank is not properly cleaned.

In a conventional approach, bottled beverage is placed in an ice bucket receiving ice cubes and can be easily removed from the ice bucket after being chilled. However, the chilling effect is not satisfactory, and ice cubes or cold water must be supplied frequently to maintain the bottled beverage at the required temperature. Furthermore, the user frequently reaching his or her hands into the cold water may be injured due to frostbite.

Taiwan Patent Application No. 97117704 filed by the applicant discloses a beverage device including a body and a detachable tank. The body receives a temperature control unit and a temperature maintaining member. The temperature maintaining member includes a heat conducting layer surrounding a receiving space. The heat conducting layer defines a passageway therein in communication with the temperature control unit. The detachable tank is received in the receiving space and includes a beverage dispenser coupled to a through-hole of the body. A medium member is coupled between the temperature member and the detachable tank. Although the tank can be detached from the receiving space of the temperature maintaining member, there is still a room for improvement in the tank and the removal of the tank.

### SUMMARY OF THE INVENTION

An objective of the present invention is to provide a beverage device including a tank receiving a beverage at a predetermined temperature.

Another objective of the present invention is to provide a beverage device including a tank that can be easily detached for cleaning purposes.

A further objective of the present invention is to provide a beverage device including a detachable tank receiving a beverage that can be preserved at the predetermined temperature for a longer period of time.

Still another objective of the present invention is to provide a temperature-conducting device for a beverage device that can be easily manufactured.

Yet another objective of the present invention is to provide a tank that can be utilized with or without a beverage device.

Still another objective of the present invention is to provide a beverage device including a tank that can be supplied with beverage when desired.

A beverage device according to the preferred teachings of the present invention includes a body having a temperature control unit outputting a temperature by a conduit unit. At least one temperature conducting device is received in the body and connected to the conduit unit, keeping the at least one temperature conducting device at a first predetermined temperature. At least one tank receives a beverage and is in connection with the conduit unit of the at least one temperature conducting device to keep the beverage at a second predetermined temperature.

A temperature-conducting device for a beverage according to the preferred teachings of the present invention includes a temperature conducting body and a shade. The shade defines a receiving space receiving the temperature conducting body. The temperature conducting body includes an outer periphery in intimate contact with an inner periphery of the shade. A seal is provided between an opening of the shade and the temperature conducting body. The outer periphery of the temperature conducting body includes a continuous passageway having a first end forming a first contact portion and a second end forming a second contact portion. The passageway extends through an interior of the temperature conducting body with the second contact portion located at an end face of the temperature conducting body.

A tank for a beverage device according to the preferred teachings of the present invention includes a receiving portion having an opening. The tank further includes a recessed bottom having a peripheral wall forming a contact portion.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows an exploded, perspective view of a beverage device of an embodiment according to the preferred teachings of the present invention.

FIG. 2 shows an exploded, perspective view of a temperature-conducting device of the beverage device of FIG. 1.

FIG. 3 shows a cross sectional view of a tank of the beverage device of FIG. 1.

FIG. 4 shows a cross sectional view of the beverage device of FIG. 1.

FIG. 5 shows an exploded, cross sectional view of the tank of FIG. 3 and a movable seat.

FIG. 6 shows an exploded, perspective view of a beverage device of a modified embodiment according to the preferred teachings of the present invention, illustrating use of a beverage bottle on the beverage device.

FIG. 7 shows a cross sectional view of the beverage device of FIG. 6.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “upper”, “top”, “bottom”, “inner”, “outer”, “end”, “portion”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

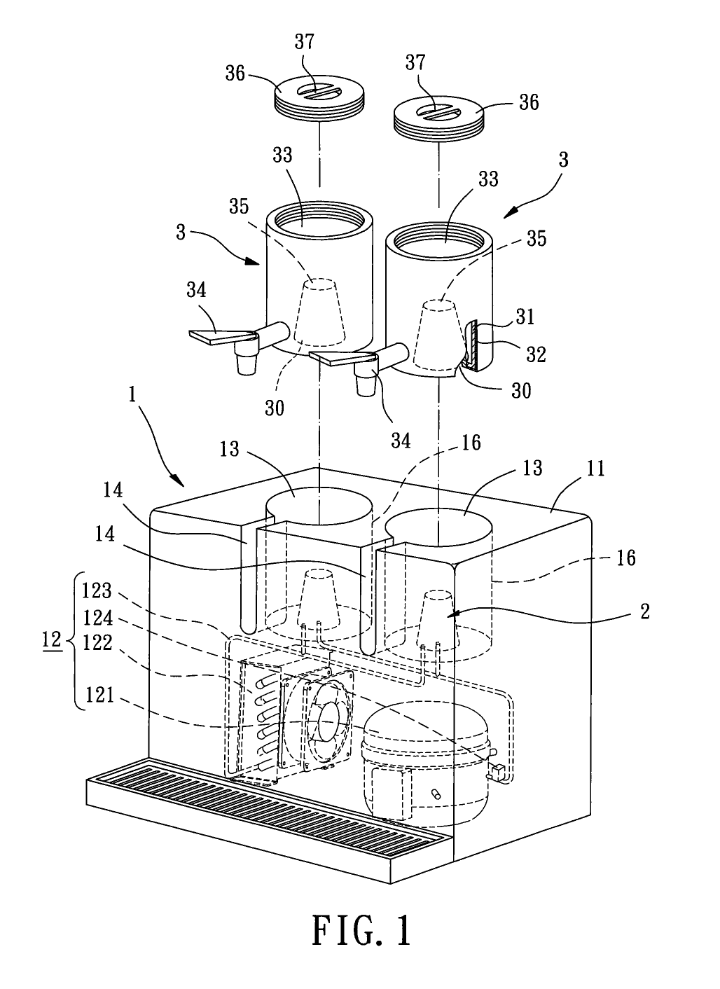

A beverage device of a first embodiment according to the preferred teachings of the present invention is shown in FIG. 1 and generally includes a body 1, two temperature conducting devices 2, and two tanks 3. Each temperature conducting device 2 is received in the body 1 and maintains one of the tanks 3 at a predetermined temperature. Each tank 3 can be detached from the body 1. It can be appreciated that the beverage device can include only one or more than two tanks 3 and a corresponding number of temperature conducting devices 2.

The body 1 includes a housing 11 receiving a temperature control unit 12. The temperature control unit 12 can be a cooling device, a heating device, or a device capable of heating and cooling. A temperature of a beverage received in each tank 3 connected to one of the temperature conducting devices 2 can be lowered or raised to a predetermined temperature. In this embodiment, the temperature control unit 12 is a cooling device and includes a compressor 121, a condenser 122, a conduit unit 123, and a temperature controlling member 124. The compressor 121 and the condenser 122 supply a low-temperature coolant that flows through the conduit unit 123 and passes through each temperature conducting device 2. The temperature controlling member 124 detects whether each temperature conducting device 2 has reached the predetermined temperature so as to control operation of the temperature conducting device 2. In this embodiment, the temperature controlling member 124 is mounted at an end of the conduit unit 123 in front of the compressor 121.

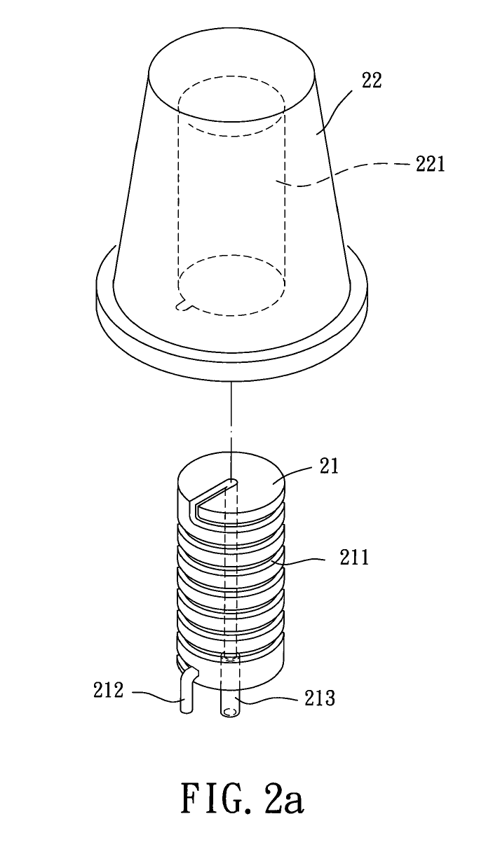

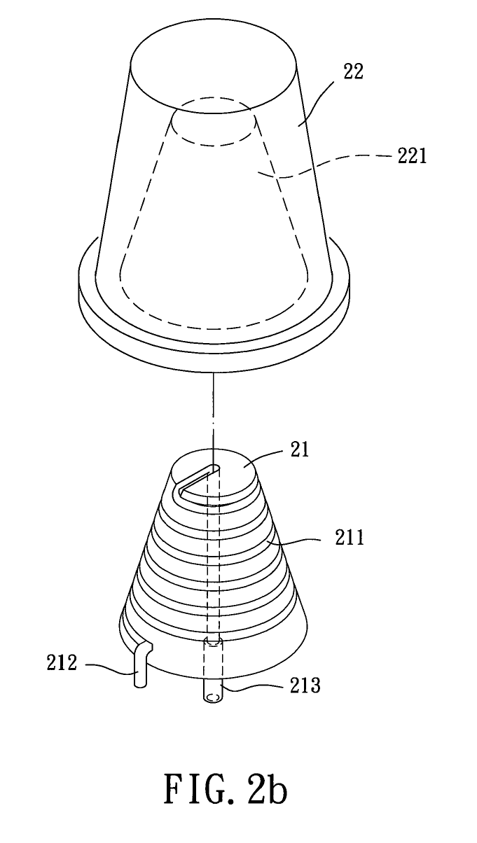

With reference to FIGS. 1, 2a and 2b, each temperature conducting device 2 is received in one of two compartments 16 of the housing 11 of the body 1. Each compartment 16 has an opening 13 in an upper side of the housing 11 to expose and to allow removal of the temperature conducting device 2 received in the compartment. The housing 11 further includes two slots 14 each extending from a front side of the housing 11 though a periphery of one of the compartments 16. Each temperature conducting device 2 is easy to manufacture. Each temperature conducting device 2 comprises a temperature conducting body 21 and a shade 22 both of which are made of a material having good heat conducting efficiency. An outer periphery of the temperature conducting body 21 is preferably in intimate contact with an inner periphery of the shade 22. Most preferably, the outer periphery of the temperature conducting body 21 and the inner periphery of the shade 22 are conic as shown in FIG. 2b. The temperature conducting body 21 is processed to form a continuous passageway 211 for the coolant. The passageway 211 is preferably helical and formed in the outer periphery of the temperature conducting body 21. A first end of the passageway 211 is a first end, and the passageway 211 extends through an interior of the temperature conducting body 21 with a second end of the passageway 211 beyond an end face of the temperature conducting body 21. A first connecting portion 212 is provided at the first end of the passageway 211, and a second connecting portion 213 is provided at the second end of the passageway 211. After the temperature conducting body 21 is received in a receiving space 221 of the shade 22, the opening of the shade 22 can be sealed by welding or by armored spacers and bolts. Since the outer periphery of the temperature conducting body 21 is in intimate contact with the inner periphery of the shade 22, the passageway 211 formed in the outer periphery of the temperature conducting body 21 forms a channel allowing the coolant to flow therethrough. One of the first and second connecting portions 212 and 213 is the input end, and the other of the first and second connecting portions 212 and 213 is the output end. It can be appreciated that even though the outer periphery of the temperature conducting body 21 is not in intimate contact with the inner periphery of the shade 22, the whole temperature conducting device 2 can still be controlled at a predetermined temperature, although the coolant may leak to from one section to another section of the helical passageway 211.

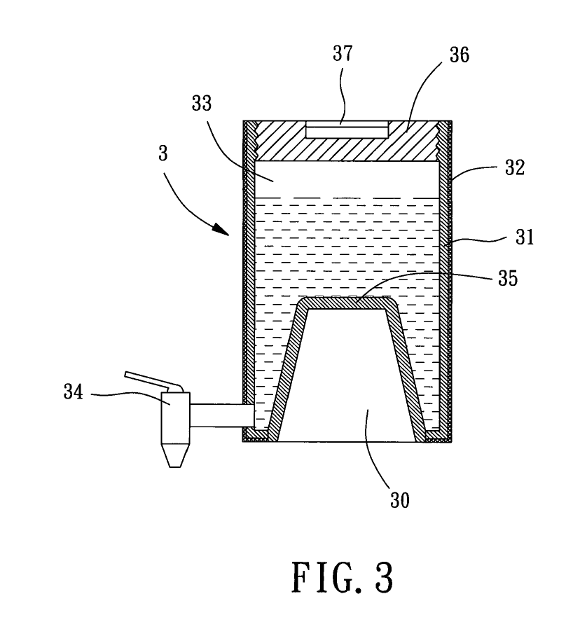

With reference to FIGS. 1 and 3, each tank 3 receives a beverage and is placed in one of the compartments of the housing 11 and in contact with one of the temperature conducting devices 2 to receive the temperature of the temperature conducting device 2, so that the temperature of the tank 3 can be controlled at the predetermined temperature. To provide the beverage in the tank 3 with the best heat conduction effect, each tank 3 includes an inner layer 31, an outer layer 32, and a cover 36. The inner layer 31 is made of a material having good heat conducting efficiency. The inner layer 31 includes a contact portion 35 and a receiving portion 33 having an opening. The receiving portion 33 receives the beverage. A beverage faucet 34 can be provided to each tank 3 to allow controllable dispensation of the beverage. When each tank 3 is received in one of the compartments 16 of the housing 11 placed on and in contact with one of the temperature conducting devices 2, the beverage faucet 34 of the tank 3 extends beyond the housing 11 via one of the slots 14 to allow easy operation. Each tank 3 further includes a recessed bottom 30 having a peripheral wall forming a contact portion 35 in a conical shape corresponding to the shade 22. Thus, when the recessed bottom 30 of the tank 3 is placed on the shade 22, the contact portion 35 can be in intimate contact with the shade 22 to provide excellent heat conducting effect for the beverage received in the tank 3. The outer layer 32 is made of heat insulating material and envelopes an outer peripheral wall of the inner layer 31 except the contact portion 35, providing excellent temperature-maintaining effect. Each cover 36 can be removably mounted to the open end of one of the tanks 3, allowing easy supply of beverage into the tank 3. In this embodiment, the cover 36 has an outer thread threadedly engaged with a threaded inner periphery of the open end of the tank 3. Furthermore, each tank 3 can include a grip 37 in the form of a handle or formed on a top face of the cover 36 to allow easy removal of the tank 3 from the housing 11 by gripping the grip 37.

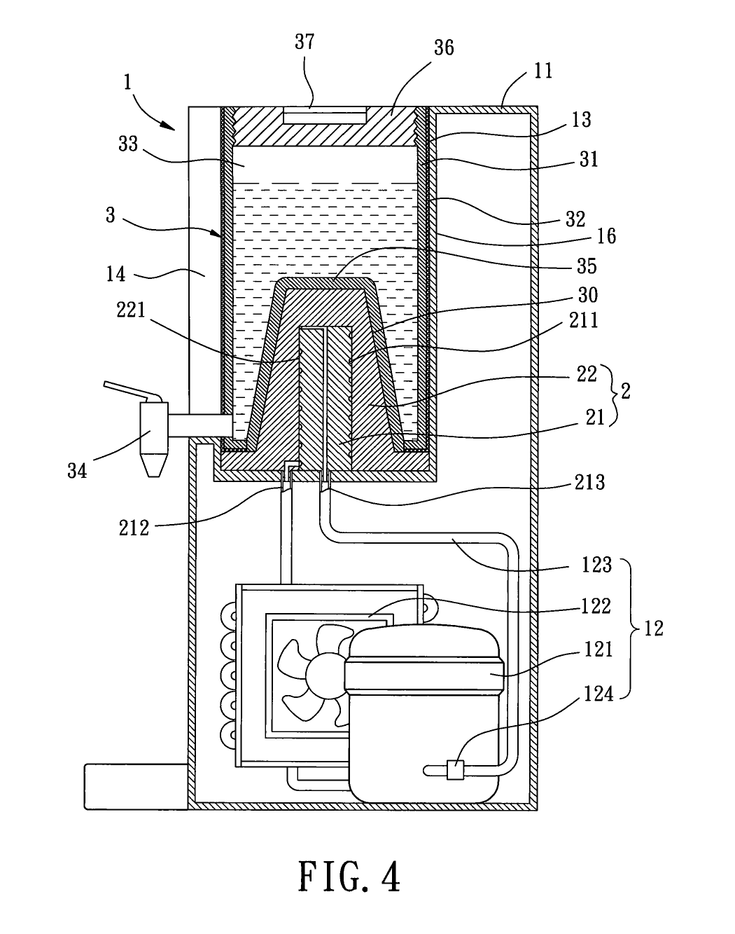

With reference to FIG. 4, the contact portion 35 of each tank 3 received in one of the compartments 16 of the housing 11 and placed on one of the temperature conducting devices 2 is in intimate contact with the shade 22 of the temperature conducting device 2. Thus, when the compressor 121 and the condenser 122 of the temperature control unit 12 are operating, the coolant flows in the conduit unit 123 to quickly lower the temperature conducting body 21 of each temperature conducting device 2 to the predetermined temperature via the shade 22, so that the beverage in each tank 3 can be at the desired temperature. Furthermore, the temperature controlling member 124 senses the temperature of the coolant flowing back from the temperature conducting device 2 to decide whether the temperature control unit 12 should be activated to raise or lower the temperature. Thus, a user can easily acquire the beverage at the desired temperature by the beverage faucet 34 on each tank 3.

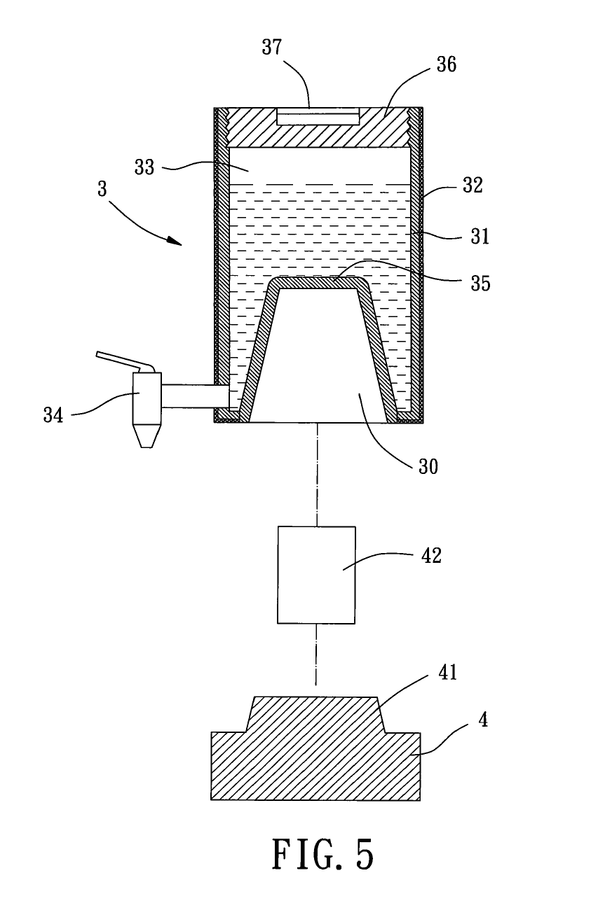

With reference to FIG. 5, when the beverage of the tank 3 placed on the temperature conducting device 2 reaches the predetermined temperature, the tank 3 can be removed from the temperature conducting device 2 and placed on a movable seat 4 with the recessed bottom 30 engaged on an insertion portion 41 of the movable seat 4 so that the tank 3 can be reliably supported on the movable seat 4. Then, a new tank 3 receiving beverage therein can be placed on the temperature conducting device 2 to lower the beverage to the predetermined temperature.

A temperature maintaining member 42 can be placed between the insertion portion 41 of the movable seat 4 and the recessed bottom 30 of the tank 3 supported on the movable seat 4, keeping the beverage in the tank 3 at the predetermined temperature for a longer period of time. As an example, the temperature maintaining member 42 can be initially stored at a predetermined temperature and then placed into a space between the insertion portion 41 of the movable seat 4 and the recessed bottom 30 of the tank 3 removed from the temperature conducting device 2 of the body 1. Thus, the beverage in the tank 3 can be kept at the predetermined temperature for a longer period of time due to sealing of the movable seat 4.

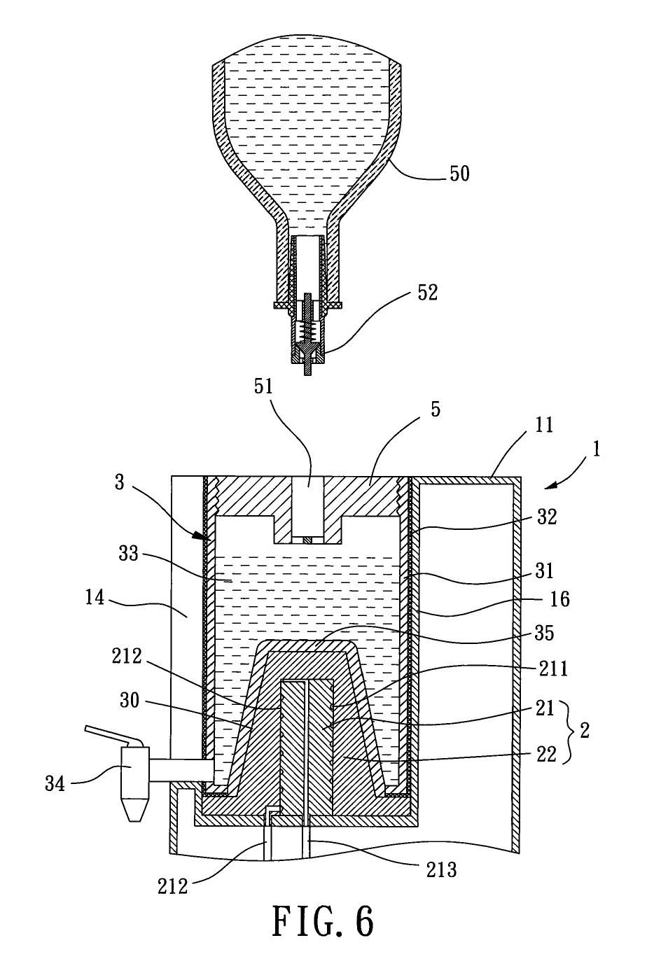

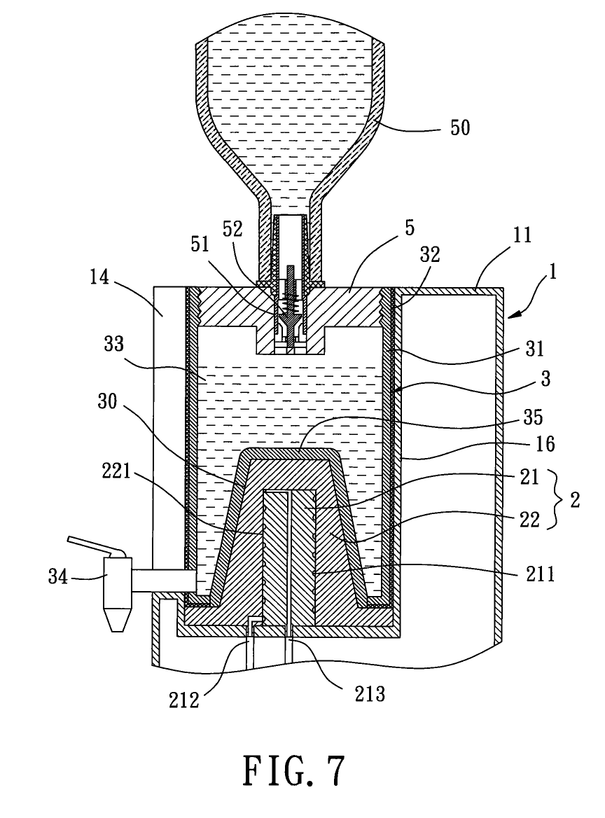

FIGS. 6 and 7 show a second embodiment according to the preferred teachings of the present invention including the body 1, the temperature conducting devices 2 and the tanks 3 the same as those in the first embodiment. Particularly, a bottle seat 5 is mounted in the opening of each tank 3 and includes a guiding hole 51. A check valve 52 mounted to a beverage-containing bottle 50 can be inserted into the guiding hole 51 of the bottle seat 5. With reference to FIG. 7, after the check valve 52 is inserted in the guiding hole 51 of the bottle seat 5, the check valve 52 is open, and the beverage in the beverage-containing bottle 50 can be automatically supplied into the tank 3.

The beverage device according to the preferred teachings of the present invention can keep the beverage received therein at the predetermined temperature. Furthermore, the tanks 3 can be easily detached from the beverage device according to the preferred teachings of the present invention for cleaning purposes. Furthermore, the tanks 3 removed from the beverage device can be kept at the predetermined temperature for a longer period of time by using the temperature maintaining member 42 according to the teachings of the present invention. Further, the tanks 3 according to the teachings of the present invention can be utilized with or without the beverage device. Further, the temperature control unit 12 according to the teachings of the present invention is easy to manufacture. Further, beverage-containing bottles 50 can be mounted to the beverage device for automatically supplying the beverage into the tanks 3.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A beverage device comprising:
a body including a temperature control unit outputting a temperature by a conduit unit;
at least one temperature conducting device received in the body and connected to the conduit unit, keeping said at least one temperature conducting device at a first predetermined temperature; and
at least one tank receiving a beverage and in connection with the conduit unit of said at least one temperature conducting device to keep the beverage located at a second predetermined temperature.

2. The beverage device as claimed in claim 1, with said at least one tank including a recessed bottom, with the recessed bottom having a peripheral wall forming a contact portion, and with said at least one temperature conducting device including a shade in intimate contact with the contact portion.

3. The beverage device as claimed in claim 1, with said at least one temperature conducting device being a cooling device.

4. The beverage device as claimed in claim 1, with said at least one temperature conducting device being a heating device.

5. The beverage device as claimed in claim 1, with said at least one temperature conducting device being a device capable of cooling and heating.

6. The beverage device as claimed in claim 1, with said at least one temperature conducting device including a temperature controlling member for operating said at least one temperature conducting device.

7. The beverage device as claimed in claim 3, with the cooling device including a compressor and a condenser for supplying a low temperature coolant to flow through the conduit unit and to pass through said at least one temperature conducting device.

8. The beverage device as claimed in claim 1, with said at least one temperature conducting device including a temperature conducting body and a shade, with the temperature conducting body including an outer periphery in intimate contact with the an inner periphery of the shade, with the outer periphery of the temperature conducting body including a continuous passageway including a first end forming a first contact portion and a second end forming a second contact portion, with the passageway extending through an interior of the temperature conducting body with the second contact portion at an end face of the temperature conducting body, with the first and second connecting portions connected to the conduit unit.

9. The beverage device as claimed in claim 1, with said at least one tank including an inner layer and an outer layer, with the outer layer made of a heat insulating material and enveloping an outer peripheral wall of the inner layer except the contact portion.

10. The beverage device as claimed in claim 1, with said at least one tank including an opening and a cover removably mounted in the opening.

11. The beverage device as claimed in claim 10, with said at least one tank including a grip mounted on a top face of the cover.

12. The beverage device as claimed in claim 1, with said at least one tank including a beverage faucet.

13. The beverage device as claimed in claim 1, further comprising a movable seat including an insertion portion, with said at least one tank being removable from the beverage device and mounted on the movable seat with the recessed bottom engaged with the insertion portion.

14. The beverage device as claimed in claim 13, further comprising a temperature maintaining member mounted between the insertion portion of the movable seat and the recessed bottom of said at least one tank.

15. The beverage device as claimed in claim 1, with said at least one tank including an opening, with a bottle seat mounted in the opening and having a guiding hole adapted to engage with a check valve of a beverage-containing bottle.

16. A temperature conducting device for a beverage device comprising a temperature conducting body and a shade, with the shade defining a receiving space receiving the temperature conducting body, with the temperature conducting body including an outer periphery in intimate contact with an inner periphery of the shade, with a seal provided between an opening of the shade and the temperature conducting body, with the outer periphery of the temperature conducting body including a continuous passageway including a first end forming a first contact portion and a second end forming a second contact portion, with the passageway extending through an interior of the temperature conducting body with the second contact portion at an end face of the temperature conducting body.

17. The temperature conducting device as claimed in claim 16, with the outer periphery of the temperature conducting body and the inner periphery of the shade being conical.

18. A tank for a beverage device comprising a receiving portion having an opening, with the tank further including a recessed bottom, with the recessed bottom having a peripheral wall forming a contact portion.

19. The tank as claimed in claim 18, with the tank including an inner layer and an outer layer, with the outer layer made of a heat insulating material and enveloping an outer peripheral wall of the inner layer except the contact portion.

20. The tank as claimed in claim 18, with the tank including a cover removably mounted in the opening.

21. The tank as claimed in claim 18, with the tank including a grip mounted on a top face of the cover.

22. The tank as claimed in claim 18, with the tank including a beverage faucet.

23. The tank as claimed in claim 18, further comprising a movable seat including an insertion portion, with the tank being removably mounted on the movable seat with the recessed bottom engaged with the insertion portion.

24. The tank as claimed in claim 23, further comprising a temperature maintaining member mounted between the insertion portion of the movable seat and the recessed bottom of the tank.

25. The tank as claimed in claim 18, further comprising a bottle seat mounted in the opening and having a guiding hole adapted to engage with a check valve of a beverage-containing bottle.
